(19) United States
(12) Patent Application Publication
(10) Pub. No.: US 2005/0052516 A1
(43) Pub. Date: Mar. 10, 2005

(54) Laminate panel for use in structrual components

(76) Inventors: John C. Wilde, Mill Creek, WA (US); Jody L. P. Finnegan, Bellingham, WA (US)

Correspondence Address: HARNESS, DICKEY & PIERCE, P.L.C., P.O. BOX 828, BLOOMFIELD HILLS, MI, 48303, US

(21) Appl. No.: 10/655,644

(22) Filed: Sep. 5, 2003

(51) Int. Cl. B41J 2/01

(52) U.S. Cl. 347/104

(57) ABSTRACT

A laminate panel especially well suited to help form an overhead stowage bin door on an aircraft, wherein the door includes a portion of a high contrast color advertising mural or message integrally formed therewith. The door includes a honeycomb support layer on which at least one fiberglass pre-preg layer is formed. A polyvinyl fluoride (PVF) film is used as a substrate for the color mural or message. A ultraviolet (UV) curable ink is deposited directly on the PVF film via an ink jet printing process that produces a high color density, high color contrast image. The PVF film in one form is a Tedlar® PVF film. The ink is cured virtually immediately after it is deposited on the PVF film. An additional layer of PVF film is then secured to a side of the printed-on PVF film opposite to that on which the ink is deposited via a layer of embossing resin to form the laminate panel. The laminate panel is then secured via a suitable adhesive to the fiberglass pre-preg and honeycomb support layer in a subsequent manufacturing step. The stowage bin door and process of making same enable a portion of a high color density, high contrast image, advertising mural or message to be integrally formed with the door.

### FIELD OF THE INVENTION

The present invention relates to laminate panels, and more particularly to a laminate panel that can be used to form an advertising system on panels such as stowage bin doors used in an aircraft.

### BACKGROUND OF THE INVENTION

In a commercial aircraft, a plurality of laterally aligned overhead stowage bin doors are typically included along the port and starboard sides of the passenger cabin of the aircraft. Larger commercial aircraft may even have one or more rows of overhead stowage bin doors located along a central area of the passenger cabin between a pair of aisles within the passenger cabin. Each of the stowage bins includes a door which can be raised by a passenger or crew member. The stowage bin doors, when closed, are readily visually apparent to the passengers and crew members within the passenger cabin area of the aircraft.

The stowage bin doors, when in their closed positions, form either relatively flat or only slightly curving surfaces. These doors could advantageously be used for supporting advertising messages. However, up until the present time, it has not been thought to provide laterally adjacent pluralities of stowage bin doors with segmented portions of a single advertising mural or message. Providing laterally adjacent stowage bin doors with segmented portions of a single advertising mural or advertising message would provide an opportunity for the airlines to use this space to generate advertising revenue through one or more advertising murals that are not only aesthetically pleasing to view, but unique from the standpoint that the entire advertising message can be presented in a much larger format than if only a single stowage bin door was employed for this purpose.

It would further be advantageous if the segmented portions of an advertising mural could each be integrally formed on separate laminate panels, via a digital printing process with the laminate panels then being used to help form respective stowage bin doors. This would allow a high contrast color image to be formed on each laminate panel. It would further allow the advertising mural to be changed by simply replacing the stowage bin doors with a different set of stowage bin doors that included a different advertising mural. Such a change could easily be effected in a very short time frame so as not to impact the profitability of the airline operating the aircraft.

Accordingly, there still exists a need in the art for an advertising system and method making use of a plurality of stowage bin doors on an aircraft to present an enlarged, advertising mural through the use of two or more, laterally adjacent stowage bin doors. Particularly, there is a need for a laminate panel that can be used to form an integral portion of a stowage bin door or any other structural panel within a mobile platform, and which is suitable for presenting a high contrast color image that can be used to help form a mural.

### SUMMARY OF THE INVENTION

The present invention is directed to a laminate panel particularly well adapted for use in forming an advertising system within a mobile platform. In one preferred form, the laminate panel is formed as a part of each one of a plurality of adjacently disposed overhead stowage bin doors on a mobile platform such as an aircraft. The laminate panels collectively help to provide an advertising mural or other form of advertising message that is segmented into several distinct sections, and the adjacent stowage bin doors are manufactured to each incorporate only one of the segments of the advertising message or mural. When the stowage bin doors are assembled onto the stowage bins, a complete rendition of the advertising mural or message is formed. Using a plurality of the stowage bin doors to present the advertising mural or message enables the mural or message to be presented in a significantly enlarged form that provides a visually dramatic presentation of the mural or message to occupants of the mobile platform.

It is also an important advantage of the present invention that the laminate panel of each stowage bin door is constructed to form an integral, permanently attached portion of the bin door. Thus, the message or mural can be quickly and easily changed simply by removing one set of stowage bin doors and attaching a different set of stowage bin doors having a different advertising message or mural incorporated thereon. Furthermore, there is no need to use adhesives or any solvents to clean the surfaces of the bin doors before the advertising message or mural can be changed. This makes the changing of the advertising mural easier and more quickly accomplished than with some arrangements that incorporate the use of adhesives for securing the advertising materials to their support panels. In addition, incorporating the advertising material into the bin door provides a fireworthy colorfast, cleanable, and abrasive, stain and solvent resistant surface.

The laminate panel of the present invention is formed by using a digital ink jet printer to deposit an ink layer directly on one layer of polyvinyl fluoride film (PVF). In one preferred implementation an ultraviolet (UV) curable and stable ink is deposited directly on a layer of Tedlar® PVF. The UV curable and stable ink is cured virtually immediately after being deposited on the Tedlar® PVF by a UV light operably associated with the printer, as the UV light passes over the newly deposited ink. The depositing of the UV curable and stable ink directly on the Tedlar) PVF eliminates the need for some type of receptive coating to be formed over the Tedlar® PVF, which would be necessary with water and solvent based digital ink jet inks. In addition, UV curable inks can allow significantly higher ink loadings on the Tedlar® PVF, in some cases possibly in excess of 300%, which is difficult, or impossible, to obtain using water or solvent based digital ink jet inks. The laminate panel, while being especially well suited for use with stowage bin doors, is just as readily able to be used with other panels used in a mobile platform.

### BRIEF DESCRIPTION OF THE DRAWINGS

The present invention will become more fully understood from the detailed description and the accompanying drawings, wherein:

FIG. 1 is a simplified perspective view of a portion of an interior passenger cabin area of a commercial aircraft illustrating an advertising mural incorporated over a plurality of overhead stowage bin doors;

FIG. 2 is a perspective, enlarged view of one of the stowage bin doors shown in FIG. 1 incorporating a laminate panel in accordance with a preferred embodiment of the present invention; and

FIG. 3 is a side, cross sectional view of the stowage bin door of FIG. 2 taken in accordance with section line 3-3 in FIG. 2 showing the various layers comprising the bin door and the structural makeup of the laminate panel.

### DETAILED DESCRIPTION OF THE PREFERRED EMBODIMENTS

The following description of the preferred embodiment(s) is merely exemplary in nature and is in no way intended to limit the invention, its application, or uses.

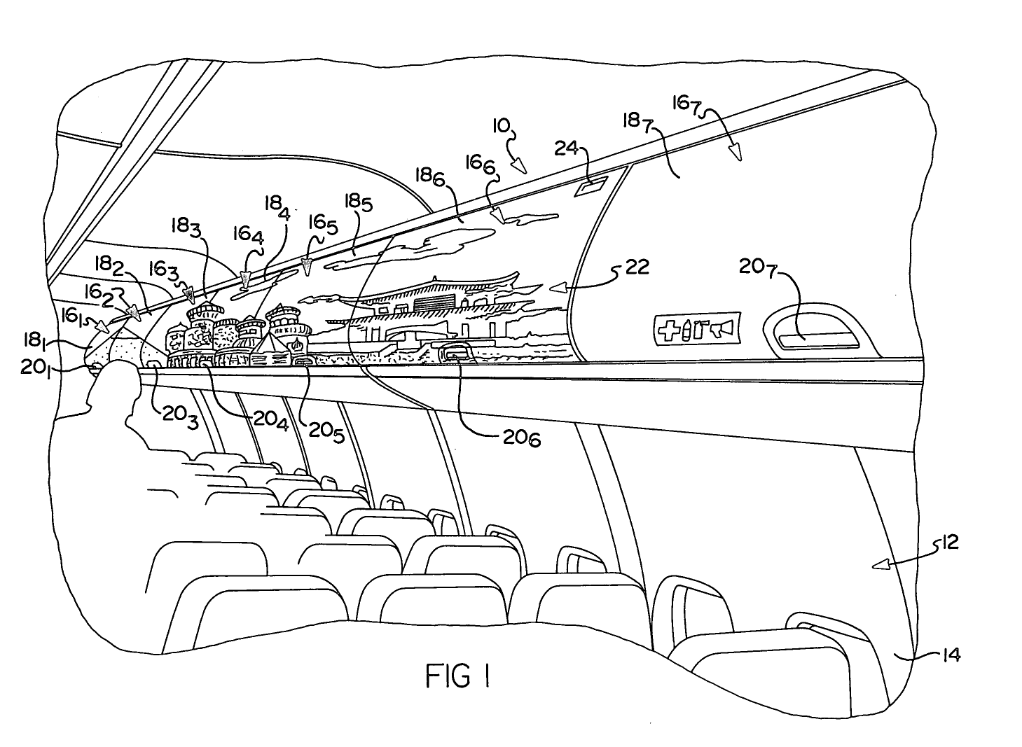

Referring to FIG. 1, there is shown an overhead stowage bin door system 10. The stowage bin door system 10 is disposed in a passenger cabin area 12 of a commercial aircraft 14. It will be appreciated that most typically, a commercial aircraft will include the stowage bin door system 10 on both the port and starboard sides of the passenger cabin 12. In larger commercial aircraft, such as a twin aisle aircraft, the stowage bin system 10 will also be present over the central area of the cabin (i.e., the area over the seats disposed between the two aisles).

The stowage bin system is comprised of a plurality of independent stowage bin doors 16₁-16ₙ, which are laterally aligned to form a generally continuous overhead storage area. Each stowage bin 16₁-16ₙ includes an associated bin door 18₁-18ₙ which may be opened via an associated user-engageable handle 20₁-20ₙ. The construction of each handle 20₁-20ₙ is conventional and will therefore not be described. In most instances, at least one stowage bin door 18 near a forward portion of the passenger cabin 12 is left free of any advertising message to comply with FAA regulations that require safety information to be present thereon with no other graphics or indicia that would detract from the noticeability of the safety information. Similarly, at least one bin door close to a midpoint of the passenger cabin area is left clear of advertising indicia, such as indicated by door 18₁, and typically one stowage bin door 18 at a rear area of the passenger cabin 12 is left free of any advertising material so as not to obfuscate or detract from the visibility of the safety information.

It is a principal advantage of the stowage bin door system 10 that each bin door 18₁-18ₙ includes a portion of an enlarged, advertising mural or message, which is designated by reference numeral 22. While reference may be made throughout the following text to “mural” 22, it will be appreciated that this includes any form of advertising message or display capable of being segmented into several distinct segments. However, since the bin doors 18₁-18ₙ are positioned laterally closely adjacent one another, when all of the bin doors are closed, a complete rendition of the single, enlarged advertising mural 22 is presented for viewing to the occupants within the passenger cabin 12.

Preferably the advertising mural 22 is comprised of vivid colors, although it will be appreciated that the colors employed on the advertising mural 22 could be muted or otherwise selected to match or blend in with the colors of the seats, carpeting, etc. within the passenger cabin area 12. To the occupants within the passenger cabin area 12, the advertising mural 22 appears as a single, generally seamless, advertising message. A company logo 24 may be included on each bin door 18 or possibly only on a single one of the bin doors 18 that make up the advertising mural 22. The doors 18 that do not include a segment of the mural 22 form natural “breaks” or dividers which can be used to separate two or more advertising murals.

It will also be appreciated that the use of the bin doors 18 for advertising purposes can represent a means for additional revenue for an airline making use of the system 10 on its aircraft. The enlarged format of each advertising mural 22 further serves to effectively attract and maintain the attention of occupants of the passenger cabin area 12. The advertising mural 22 may be selected to provide a certain theme within the aircraft, such as an oriental theme if the aircraft is typically employed for travel to the Orient. Furthermore, depending upon the colors employed, the advertising mural 22 could help to provide a relaxing ambience within the aircraft 14 if the aircraft is employed on relatively long flights.

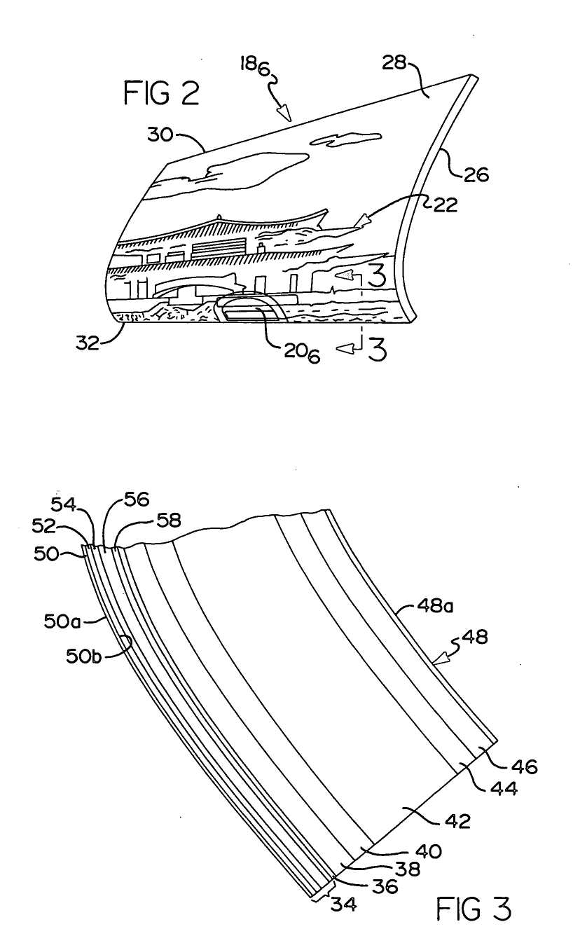

Referring to FIGS. 2 and 3, the construction of each bin door 18, and particularly a construction of a laminate panel in accordance with a preferred embodiment of the present invention, will be described. Each bin door 18 includes an inner surface 26 and an outer surface 28. The inner surface 26, near an upper edge 30, typically includes one or more hinges (not shown) for enabling the bin door 18 to be secured to its associated storage bin 16. The handle 206 is included along the lower edge 32 so as to be easily accessible by an occupant.

With specific reference to FIG. 3, each bin door 18 comprises a decorative laminate panel 34 in accordance with a preferred embodiment of the present invention. The laminate panel 34 is made up of a plurality of independent layers that will be described in detail momentarily. The decorative laminate panel 34 is disposed against an adhesive layer 36 which may comprise spray or heat activated adhesive. One suitable adhesive is available from Bostic Findley, Inc. This adhesive layer is typically applied with a dry film coverage of 2 to 3 grams/ft². The adhesive layer 36 is formed on a substrate which in one preferred form comprises a pre-preg fiberglass layer 38. Pre-preg fiberglass layer 38, in one preferred form, comprises a 120 weave style, although it will be appreciated that other weave styles could also be employed. Pre-preg fiberglass layer 38 is also positioned against a pre-preg fiberglass layer 40. Pre-preg fiberglass layer 40 may comprise a 181 weave style, but again, it will be appreciated that other weave styles could be employed. In addition, there may be small pieces (doublers) of prepreg material placed in key locations to improve surface and/or edge quality. Still further, other materials such as carbon could be employed in lieu of fiberglass.

With further reference to FIG. 3, pre-preg fiberglass layer 40 is positioned against a honeycomb core 42 typically having a thickness in the range of about 0.360 inch-0.500 inch (9.14 mm-12.7 mm). Again, this thickness could be varied. Also, the honeycomb core 42 could be OX formed (i.e., elongated more in the direction normal to the ribbon direction) if desired. Preferably, additional pre-preg layers 44 and 46 are also formed against one another, with layer 44 being formed against the honeycomb core 42. Pre-preg fiberglass layer 44 preferably incorporates a 181 weave style while pre-preg fiberglass layer 46 preferably incorporates a 120 weave style, however, other weave styles could readily be incorporated. Finally, a polyvinyl film 48 is placed against the pre-preg fiberglass layer 46 to form the inside surface. In one preferred form the polyvinyl film 48 comprises a layer of Tedlar® PVF (polyvinyl fluoride) film having a thickness of preferably about 2 mills. The Tedlar® PVF film 48 is also preferably opaque, and more preferably comprises a light color such as white, a light beige or a light grey. An outer surface 48a of the Tedlar® PVF film essentially forms the inside surface 26 of the bin door and further preferably includes a slight texture which is maintained by the resins in the pre-preg fiberglass layers 46 and 44 once these layers cure during the manufacturing process.

With further reference to FIG. 3, the decorative textured laminate panel 34 will now be described. Laminate panel 34 forms the outer surface 28 of the bin door 18₆. Laminate panel 34 is comprised of a very thin polyvinyl film 50 having a texture on its outer surface 50a. Film 50, in one preferred form, comprises a Tedlar® PVF film having a thickness of preferably about 1 mill. The Tedlar® PVF film 50 is also preferably a clear gloss or a semi-gloss layer, but in either event it is substantially translucent. Layer 52 represents the ink that comprises the image of advertising mural 22. The ink layer 52 is formed on an inside surface 50b of film 50. A second polyvinyl film layer 54 is preferably disposed against the rear surface 50b of PVF film 50. Layer 54 also preferably comprises a Tedlar® PVF film having a thickness of preferably about 2 mills. Tedlar) PVF layer 54 is also preferably white in color to form a suitable background against which the colors of the ink layer 52 stand out against, although it will be appreciated that other colors could be employed depending on the color scheme used in the mural 22. Printing on the inside surface 50b of film 50 eliminates the need to place a protective covering over the layer 50 since the film 50 itself forms a protective barrier for the ink layer 52. However, printing on the inside surface 50b requires that the image or advertising mural be transposed during the printing process so that it appears correct when viewed from the opposite side (i.e., frontside 50a) of film 50. Alternatively, the ink layer 52 could be formed on the second polyvinyl film layer 54, which would also eliminate the need to transpose the image during the printing process.

It is an important aspect of the construction of the laminate panel 34 of the present invention that the ink layer 52 is deposited by a suitable digital ink jet printer directly on the Tedlar® PVF film 50. The ink used to form ink layer 52, which makes up the mural 22, preferably comprises an ultraviolet (UV) curable and stable ink (black or colored) that is deposited directly on the Tedlar® PVF film 50. The ink is cured virtually immediately after being deposited by the ink jet printer via a UV light operably associated with the digital ink jet printer that passes over the newly deposited ink as the ink is deposited. The use of UV curable ink allows the ink to be deposited directly on the Tedlar® PVF film 50 (or even on layer 54) without the need for some type of receptive coating to be placed over Tedlar® PVF film 50 or 54, which would be necessary with water or solvent based digital ink jet inks. Advantageously, the Tedlar® PVF films 50 and 54 form a fireworthy material that meets Federal Aviation Administration fire safety requirements for materials used on commercial aircraft. The ability of the UV curable ink to be cured virtually immediately after being deposited on the Tedlar® PVF film 54 or 50 also simplifies and expedites the manufacturing of the laminate layer 34. In addition, UV curable inks allow ink loadings on the Tedlar® PVF in excess of 300% without the use of coatings which would be difficult, or impossible, to obtain using water or solvent based digital ink jet inks

The decorative textured laminate panel 34 further includes a layer 56 comprised of an embossing resin and another layer of polyvinyl material 58 which is disposed against the adhesive layer 36. Polyvinyl layer 58 also preferably comprises a Tedlar® PVF material having a thickness of preferably around 2 mills. Layer 58 is also preferably white in color. The layer of embossing resin 56 may vary significantly, but in one preferred form comprises an arial weight of 0.023 lb/ft² to 0.031 lb/ft².

As described above, the ink layer 52 is most preferably applied by a suitable ink jet printer or printing process. Companies making suitable ink jet printers or printing equipment that employ a high quality ink are Vutek of Meredith, N.H. and 3M Corp. of Maplewood, Minn. Other suitable inks are available from Sericol, Inc. of Kansas City, Kans. and Sunjet of Bath, England.

The color image formed by the advertising mural 22, in one preferred form, comprises a high contrast color image which is highly aesthetically pleasing to view. The decorative textured laminate panel 34 is formed in a conventional multi-opening press which uses heat and pressure to laminate the individual layers making up laminate panel 34 together as a single, decorative, textured laminate structure. The textured outer surface 50a of the Tedlar® PVF layer 50 is maintained by the embossing resin of layer 56 as the resin cures in the multi-opening press during manufacture. The decorative texture laminate panel 34 is then combined with the remaining layers 36-48 in a conventional vacuum forming IR oven to form the remainder of the stowage bin door 18. Some trimming of excess material or edge wrapping of laminate section 34 may be required to achieve maximum aesthetic appeal.

While the laminate panel 34 has been described in connection with the manufacture of a stowage bin door, it will be appreciated that the laminate panel 34 is just as readily useable to help form any other type of structural panel. In some instances, the laminate panel 34 may by itself be used to form a complete structural panel. Still further, the laminate panel 34 is not limited to displaying just advertising content, but could obviously be used to provide any type of information.

It is an advantage that the advertising mural 22 thus forms an integral portion of each of the bin doors 18 that form the mural 22. Thus, changing the advertising mural 22 can be accomplished quickly and easily simply by removing the bin doors 18 that have the advertising mural 22 thereon and substituting a different set of bin doors with a different advertising mural. Thus, there is no need to try and remove independent advertising placards from adhesive layers and to reapply new advertising placards. The ability to change the advertising mural without having to deal with adhesives is a significant advantage of the present invention. By integrally forming the advertising mural 22 with each of the bin doors 18, changing of the advertising mural can be accomplished more easily and quickly than with previously developed advertising placards. Thus, there is no need to remove the aircraft from service for an extended period of time simply to change the advertising mural 22.

The laminate panel of the present invention thus enables images, messages or advertising murals to be implemented using the stowage bin doors of an aircraft (or any other type of structural panel) in a manner that does not interfere with use of the stowage bin doors, and further that does not interfere with maintenance of the aircraft or with any of the safety designations on various ones of the stowage bin doors.

It will also be appreciated that while the stowage bin doors 18 form a particularly convenient surface for presenting the mural 22, other interior surfaces, such as a ceiling area, could just as readily be employed for the purpose of presenting the mural. Such an area would be more suitable for presenting a mural that is not intended to be changed frequently, whereas the stowage bin doors are ideally suited for murals that will be changed periodically.

The laminate panel of the present invention further allows for construction of the stowage bin doors with a designated portion of an advertising mural or message printed thereon in a permanent construction. As such, changing of the advertising mural or message can be quickly and easily accomplished by simply changing the stowage bin doors with a different set of doors having a different mural/message. The use of ink jet printing technology to print directly on one of the Tedlar® PVF layers further simplifies the manufacture of the overall door, while providing a high contrast color image to be formed.

The description of the invention is merely exemplary in nature and, thus, variations that do not depart from the gist of the invention are intended to be within the scope of the invention. Such variations are not to be regarded as a departure from the spirit and scope of the invention.

1. A laminate panel for use within a mobile platform to present at least a portion of an image thereon, the panel comprising:
a first substrate comprised of a polyvinyl fluoride;
an image printed via an ink jet printing process directly on said first substrate to form at least a designated portion of said image thereon; and
a second substrate secured to said first substrate to support said first substrate; and
wherein said second substrate and said first substrate cooperatively form an integrally constructed laminate panel.

2. The panel of claim 1, wherein said panel is fixedly secured to a supporting panel to form a stowage bin door used with an overhead stowage bin on an aircraft.

3. (cancelled)

4. The panel of claim 1, further comprising an ultraviolet stable ink used to form said image.

5. The panel of claim 1, further comprising a honeycomb support layer disposed adjacent said second substrate.

6. The panel of claim 2, wherein said supporting panel comprises a plurality of fiberglass layers; and
a honeycomb layer interposed between said plurality of fiberglass layers.

7. The panel of claim 2, wherein said supporting panel comprises a carbon panel.

8. The panel of claim 1, wherein said second comprises a polyvinyl fluoride film.

9. The panel of claim 1, further comprising an embossing resin for securing said first substrate to said second substrate.

10. The panel of claim 9, wherein said second substrate comprises a polyvinyl fluoride film.

11. (cancelled)

12. A stowage bin door for use with a stowage bin of an aircraft, the stowage bin door comprising:
a supporting panel;
a substrate;
a color image printed directly on said substrate through a digital printing process to form a high contrast color image;
a film for covering one surface of said substrate without substantially affecting said contrast of said color image; and
wherein the supporting panel, the substrate and the film are integrally constructed to form the stowage bin door, and wherein the substrate and film form a non-removable laminate panel of the stowage bin door.

13. The stowage bin door of claim 12, further comprising a honeycomb layer disposed adjacent said supporting panel.

14. The stowage bin door of claim 12, further comprising an embossing resin disposed on said film for securing said film to said fiberglass panel.

15. The stowage bin door of claim 12, wherein:
said supporting panel comprises a fiberglass pre-preg panel; and
wherein said stowage bin door further includes an adhesive layer for securing said laminate panel to said fiberglass pre-preg panel.

16. The stowage bin door of claim 12, wherein said supporting panel comprises:
a pair of fiberglass pre-preg layers; and
a honeycomb structure interposed between said fiberglass pre-preg layers.

17. (cancelled)

18. The stowage bin door of claim 12, wherein said high contrast color image is comprised of an ultraviolet (UV) curable ink applied via a digital ink jet printing process.

19. A door panel for use within a mobile platform, comprising:
a support layer;
a polyvinyl fluoride (PVF) film; and
an ultraviolet (UV) curable ink forming an image directly on said PVF film through an ink jet printing process; and
wherein said image forms an integral portion of said panel and is not removable therefrom.

20. (cancelled)

21. The door panel of claim 19, further comprising:
a honeycomb layer disposed against said support layer; and
a fiberglass pre-preg layer disposed against said honeycomb layer on a side opposite to that of said support layer.

22. The door panel of claim 19, further comprising an adhesive layer for securing said PVF film to said support layer.

23. The door panel of claim 19, further comprising an opaque supporting layer of polyvinyl fluoride film secured to said PVF film.

24. The door panel of claim 19, wherein said ink comprises a color ink for forming a high contrast color image.

25. A method for forming an interior panel for use within a passenger area of a mobile platform, the method comprising:
using a support layer for said interior panel;
using a printer to deposit a ultraviolet (UV) curable ink directly on a polyvinyl fluoride (PVF) film to form an image thereon; and
curing the UV curable ink virtually immediately after depositing said UV curable ink on said PVF film; and
permanently securing said PVF film to said support layer.

26. The method of claim 25, wherein using a printer comprises using a digital ink jet printer.

27. (cancelled)

28. The method of claim 25, further comprising securing an opaque supporting PVF layer to said PVF film.

29. A method for forming a stowage bin door for use with an overhead stowage bin on an aircraft, the method comprising:
using a support layer;
using a layer of polyvinyl fluoride (PVF) film to receive thereon a ultraviolet (UV) curable ink deposited via an ink jet printing process directly on the PVF film;
adhering a film layer to said PVF film to form a laminate structure; and
using an adhesive to fixedly secure the laminate structure to the support layer.

30. (cancelled)

31. The method of claim 29, further comprising securing a honeycomb support structure to the support layer.

32. The method of claim 29, wherein securing a film layer comprises securing an opaque PVF film to said PVF film.
